(19) United States
(12) Patent Application Publication
(10) Pub. No.: US 2021/0367775 A1
(43) Pub. Date: Nov. 25, 2021

(54) Devices, Systems, And Methods For Providing Security To IoT Networks And Sensors

(71) Applicant: Sectigo, Inc., Roseland, NJ (US)

(72) Inventor: Alan Grau, Des Moines, IA (US)

(21) Appl. No.: 17/327,155

(22) Filed: May 21, 2021

Related U.S. Application Data
(60) Provisional application No. 63/028,163, filed on May 21, 2020.

(51) Int. Cl. H04L 9/08; H04L 9/32; H04L 29/08; G16Y 30/10

(52) U.S. Cl. CPC H04L 9/0869; H04L 9/085; G16Y 30/10; H04L 67/12; H04L 9/3213

(57) ABSTRACT

The disclosure is related to a method for performing secure boot for IoT sensors where the verification process is done collaboratively between the sensor and the gateway. Further, a method of performing secure updates for IoT sensors where the verification process is done on the gateway. A method of authenticating an IoT sensor with an IoT gateway in which a first method of authentication is used upon first installing a device and occasionally thereafter and a second method is used for transactional communication. Still further, a method of computing an encryption key from a seed value that utilizes information specific to the sensor to create an encryption key unique to that sensor.

### CROSS-REFERENCE TO RELATED APPLICATION(S)

This application claims priority to U.S. Provisional Patent Application No. 63/028,163, filed May 21, 2020 and entitled “Devices, Systems, And Methods For Providing Security To IoT Networks And Sensors,” which is incorporated herein in its entirety by this reference.

### TECHNICAL FIELD

The disclosure relates to internet of things (IoT) sensors, IoT networks, gateways, and devices, systems, and methods related thereto.

### BACKGROUND

IoT devices and networks exist throughout the world. Each device on the network must be secured. As such there is a need in the art for improved devices, systems, and methods for securing IoT devices and networks.

### BRIEF SUMMARY

Disclosed herein are various security methods and related devices and systems for use with IoT networks.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for authenticating an IoT device including establishing communication between a sensor and a gateway. The method also includes verifying a sensor ID on the gateway. The method also includes generating an authentication token on the gateway. The method also includes receiving the authentication token by the sensor. Other embodiments of this aspect include corresponding computer systems, apparatus, and computer programs recorded on one or more computer storage devices, each configured to perform the actions of the methods.

Implementations may include one or more of the following features. The method further including generating an encryption key seed on the gateway. The method may also include receiving the encryption key seed by the sensor. The methods further including computing an encryption key from the encryption key seed. Implementations of the described techniques may include hardware, a method or process, or computer software on a computer-accessible medium.

One general aspect includes a method for provisioning an IoT device with authentication credentials including installing a sensor on a sensor network, configuring a gateway with a sensor ID of the sensor, establishing communication between the sensor and the gateway, and verifying the sensor ID on the gateway. The method also includes generating an authentication token on the gateway, sending the authentication token from the gateway to the sensor, receiving the authentication token by the sensor, and storing the authentication token on the sensor. Other embodiments of this aspect include corresponding computer systems, apparatus, and computer programs recorded on one or more computer storage devices, each configured to perform the actions of the methods.

Implementations may include one or more of the following features. The method further including generating an encryption key seed on the gateway. The method may also include receiving the encryption key seed by the sensor. The methods further including computing an encryption key from the encryption key seed. Implementations of the described techniques may include hardware, a method or process, or computer software on a computer-accessible medium.

One general aspect includes a method for secure booting of an IoT device including powering on the IoT device, computing a hash of firmware on the IoT device, sending the hash to a gateway, verifying the IoT device on the gateway, retrieving a validation key and a signature on the gateway, decrypting the signature and deriving an expected hash value, and comparing the expected hash value to the hash. Other embodiments of this aspect include corresponding computer systems, apparatus, and computer programs recorded on one or more computer storage devices, each configured to perform the actions of the methods.

Implementations may include one or more of the following features. The method further including sending an authentication token and encryption key seed to the IoT device. The method further including reporting a security event when the expected hash value and the hash do not match. Implementations of the described techniques may include hardware, a method or process, or computer software on a computer-accessible medium.

One general aspect includes a method for performing secure updates on an IoT device including downloading new firmware and a firmware signature, decrypting the firmware signature with a validation key to derive an expected hash value, calculating a hash value for the new firmware, and comparing the expected hash value to the hash value. Other embodiments of this aspect include corresponding computer systems, apparatus, and computer programs recorded on one or more computer storage devices, each configured to perform the actions of the methods.

Implementations may include one or more of the following features. The method further including updating the IoT device if the expected hash value and hash value match. The method further including reporting a security event if the expected hash value and the hash value do not match. Implementations of the described techniques may include hardware, a method or process, or computer software on a computer-accessible medium.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic diagram of the system, according to one implementation.

FIG. 2 is a flow diagram of a code signing process, according to one implementation.

FIG. 3 is a flow diagram of a code validation process, according to one implementation.

FIG. 4 is a flow diagram showing a process for authentication of sensors, according to one implementation.

FIG. 5 is a flow diagram showing a process for authentication of sensors, according to one implementation.

FIG. 6 is a flow diagram for securely booting a device, according to one implementation.

FIG. 7 is a flow diagram for secure updates, according to one implementation.

FIG. 8 is a schematic depiction of a code signing system, according to one implementation.

### DETAILED DESCRIPTION

This disclosure relates to methods for implementing security controls on IoT sensors and other IoT devices without requiring additional hardware and/or computational capability on the sensor or device itself.

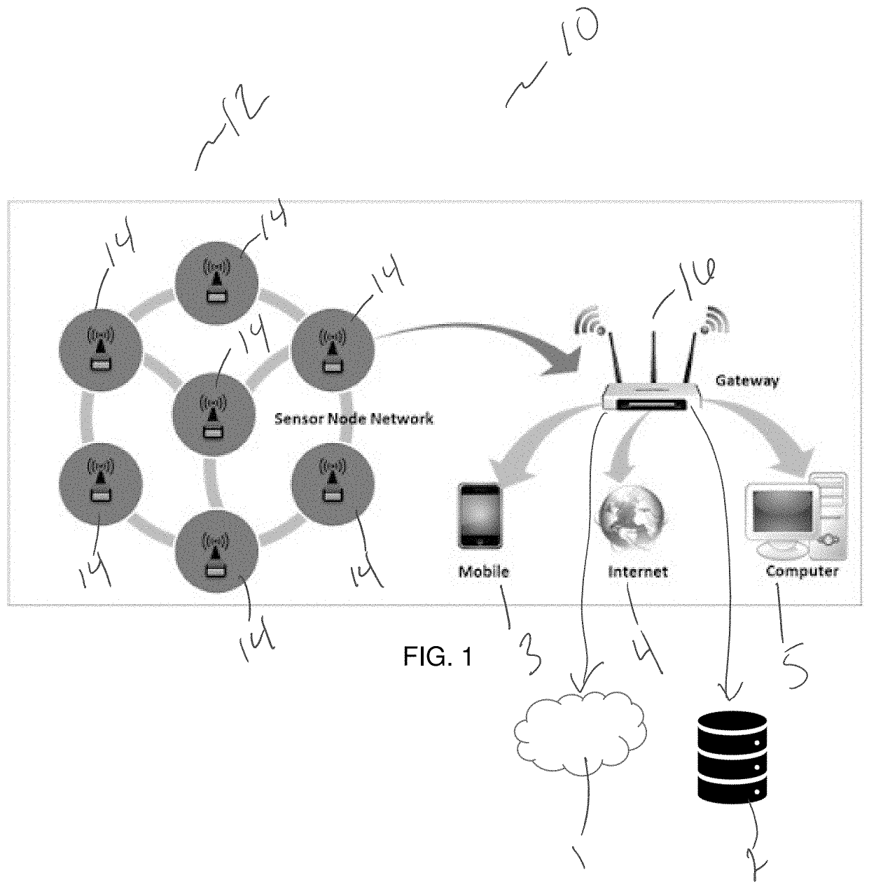

As shown, for example in FIG. 1, an IoT network 10 may include a low power IoT sensor network 12 which operates using a combination of a low power, often battery powered, sensor devices 14. These low power IoT sensors 14 may then communicate to an IoT gateway 16 over a wireless protocol such as ZigBee, Bluetooth, Bluetooth Low Energy (BLE), Z-Wave, 6LoWPAN, Thread, NB-IoT, LoRaWAN, or a similar protocol. The IoT gateway 16, in turn, communicates to an IoT cloud 1 or server system 2. In some implementations, the IoT gateway 16 may additionally be in communication with mobile devices 3, the internet 4, and/or computer(s) 5. Security is a critical concern for IoT networks 10, and all devices 14 in the network 12 should be secured.

In some implementations, various wireless sensor networks 10 include a plurality of sensor nodes 14. These sensor nodes 14 are often very low-cost devices that are configured to collect information and send it to a gateway 16. The gateway 16, also referred to as a sink or data sink, collects data from the sensor nodes 14. The gateway 16 may then collate the data and other information and send it to a cloud system 1. In various implementations, the gateway 16 may also send control, configuration, and other updates to the sensor nodes 14.

The cloud system 1 may be constructed and arranged to collect and analyze data from the gateway 16 and sensor nodes 14. In further implementations, the cloud system 1 may also use the data for a variety of applications. For example, the cloud system 1 may perform analysis and/or decision making that controls workflows or other devices based on the data collected by the IoT sensors 14. In some implementations, the cloud 1 or server system 2 may perform analysis and/or decision making that controls workflows or other devices based on the data collected by the IoT sensors 14. In other implementations, the gateway 16 may make some or all of those decisions.

While IoT sensor networks 12 and IoT gateways 16 are capable of supporting security controls, many IoT sensor networks 12 are built using very low-cost hardware that is not capable of supporting modern security controls, such as secure boot, secure firmware updates, and strong authentication.

As such, various existing systems either do not implement secure boot on IoT sensors 14 or implement very weak validation checks such as a Cyclic Redundancy Code (CRC) or hash validation of the firmware on the IoT sensors 14 for secure boot and secure updates. For authentication, these IoT sensors 14 often utilize a shared secret (i.e. a password), which is not as secure as modern authentication methods using PKI and certificates. These known networks 12 may require adding additional hardware to sensor devices 14 to implement authentication protocols, which increases the cost of the devices 14.

In many implementations, IoT devices 14 and sensors 14 are cost sensitive products such that adding additional cost is not practical or possible. Further, additional hardware components may impact battery usage, shortening the usable life of the device 14. Some sensor devices 14 are designed to operate for the full life of the product without replacing the batteries. Many of these devices 14 are installed in locations that cannot be practically serviced to replace batteries or replace the devices 14 without significant cost, making the addition of hardware that requires additional processing impractical.

Described herein are methods and associated devices and systems for improving upon current security solutions for low cost IoT sensor devices 14 by providing robust security solutions that do not require new hardware capabilities (and cost) be added to the devices 14. Various implementations utilize the processing capabilities of the IoT gateway 16 to assist with the code validation required to implement secure boot and secure firmware updates. The terms firmware and software are used to describe code running on a device and can be used interchangeably, as would be understood. Further implementations also utilize the processing capability of the gateway 16 to assist with device 14 authentication, enabling strong authentication without overburdening the sensor devices 14.

### I. Code Signing and Validation

In various implementations, the system 10 described herein includes methods for ensuring that code is authentic, for example, that the code is from the original equipment manufacturer (OEM) and has not been modified. Further, the various implementations provide protection again various cyber-attacks, including but not limited to attacks where a bad actor attempts to (i) access a device and modify the firmware or add new malicious firmware, (ii) access a device and replace the firmware or software with malicious firmware/software, and/or (iii) utilize software update mechanisms to install malicious firmware through devices, sensor, and/or gateways update processes. These methods and systems may comprise one or more optional steps that can be performed in any order or not at all.

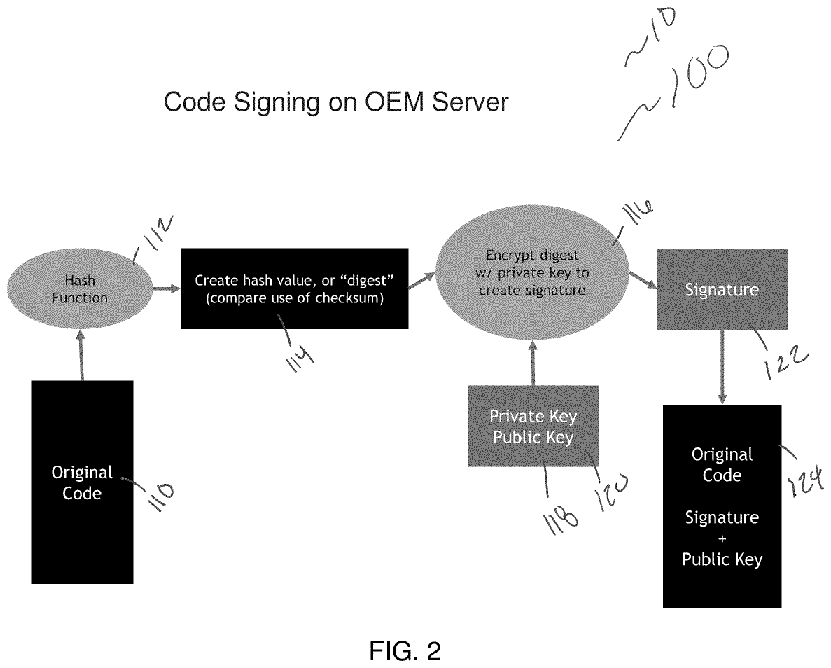

FIG. 2 depicts a process 100 flow for code signing on an OEM server. In one optional step, the original code 110 is inputted into a hash function 112 to create a hash value or digest 114. In another optional step, the digest 114 is encrypted 116 with a private key 118 to create a signature 122. In another optional step, the signature 122 is saved along with the original code 110 and the public key 120 referred to herein as the signed code 124.

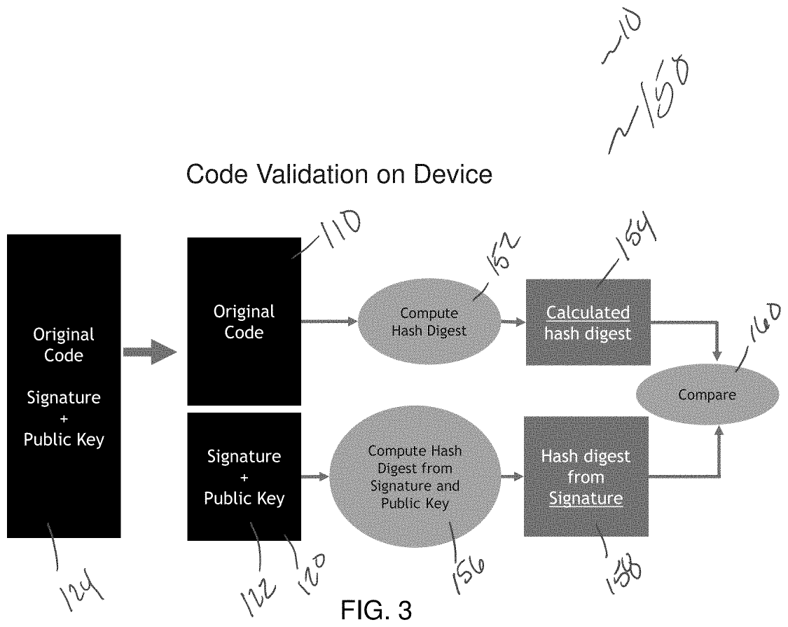

A further optional process 150 for validating the code on the device 14 is shown for example in FIG. 3. In one optional step, the signed code 124 is processed on the device 14 to separate the original code 110 from the signature 122 and public key 120. In another optional step, on the device 14, the original code 110 is used to compute 152 a code hash digest 154.

In a further optional step, the signature 122 and public key 120 are used to compute 156 a signature hash digest 158, by decrypting the signature 122 with the public key 120. In another optional step the original code hash digest 154 is compared 160 to the signature hash digest 158 of the code as computed on the device 14.

### II. Authentication

In various implementations, the system 10 can authenticate the device 14 as part of an initial provisioning of authentication credentials and/or as part of authorizing communications with the device 14. The authentication process 200 may involve a series of steps and substeps, each of which is optional and may be performed in any order or not at all.

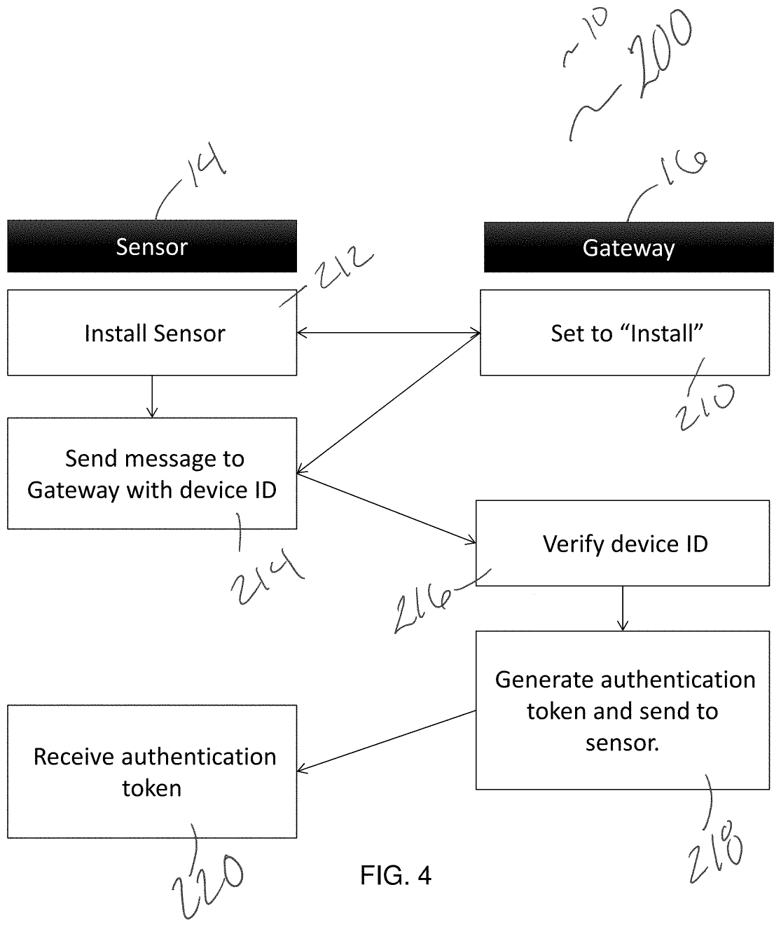

One exemplary implementation of an authentication system 200 is shown in FIG. 4. In one optional step, the gateway 16 can be set to installation mode (box 210) via a command. In various alternative implementations the set to installation mode (box 210) command may be initiated by a cloud system 1, mobile device 3, or other computer system 5. In some implementations, the command is sent to the gateway 16 via the cloud system 1. For example, the command to set the gateway 16 to installation mode may be initiated by a user via an application.

In another step, the sensor 14 is installed (box 212) into the network 12. In various implementations, the steps of setting the gateway 16 to installation mode (box 210) and of installing the sensor 14 on the network 12 (box 212) are optionally part of a method for provisioning the sensor 14 with authentication credentials. In various implementations, a sensor device ID is pre-programmed on the IoT gateway 16. The sensor 14 may send a beacon or broadcast message to the gateway 16 with its device ID (box 214). In various alternative implementations, the gateway 16 may initiate communication with a sensor 14, for example, as a result of an installation mode command.

In various alternative implementations, the sensor 14 may already be installed on the network 12, and the authentication processes may begin by the sensor 14 sending a message to the gateway 16. In these and other implementations, the sensor 14 uses less battery and bandwidth than when installation is required.

In some implementations, the messages between the IoT sensor 14 and the gateway 16 are sent over any known communication protocol as would be supported by a particular IoT system 10, as would be appreciated by those of skill in the art. In some implementations, this communication link is encrypted. In implementations where the IoT protocol does not include encryption at the transport layer, encryption may be added to the application layer.

In various implementations, after a communication link is established by the sensor 14 and the gateway 16 the authentication process 200 may run at the application layer. In further implementations, the communication link establishment has an independent authentication and/or handshake process, as would be recognized.

In a further optional step, the gateway 16 may verify that the device ID (box 216) is valid by comparing the device ID sent from the sensor 14 to the preprogrammed device ID. The gateway 16 may then generate an authentication token and send the authentication token to the sensor 14 (box 218).

In another optional step, the sensor 14 receives the authentication token (box 220). The sensor 14 may then save the authentication token for use in subsequent sessions.

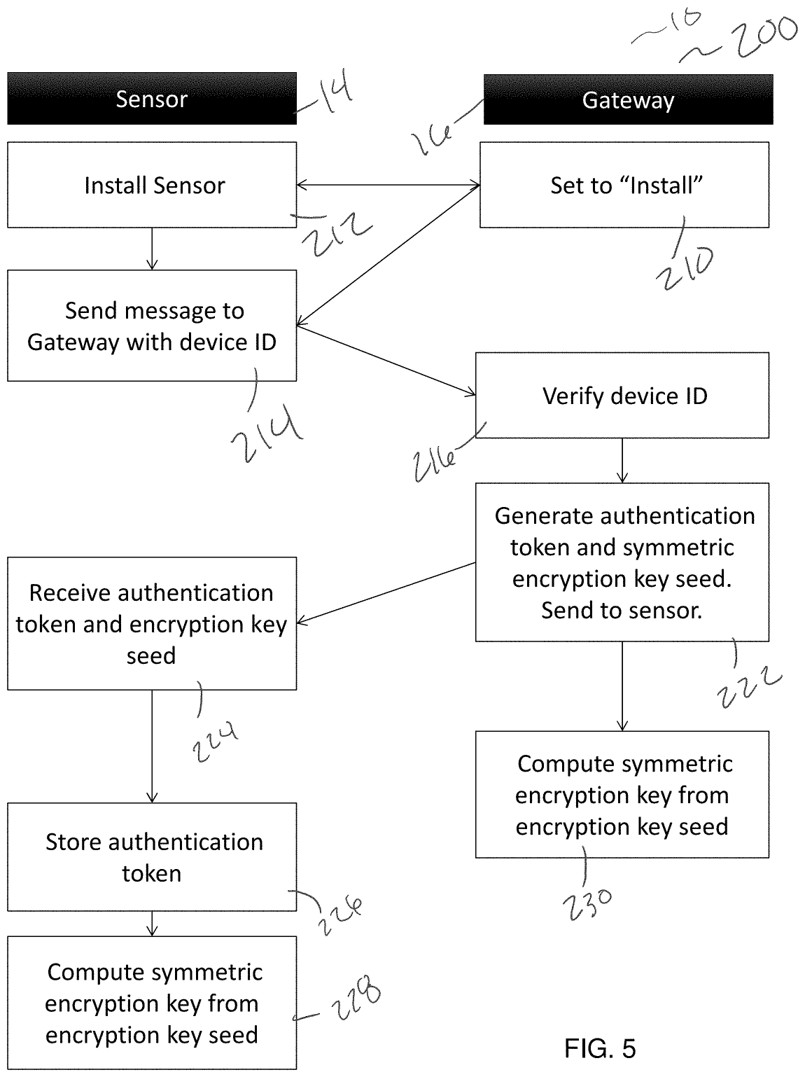

In various implementations, the authentication system 200 includes key establishment for the sensors 14, as shown for example in FIG. 5. In some implementations, the system 200, in an optional step, generates a symmetric encryption key seed and sends it to the sensor 14 along with an authentication token (box 222). In another optional step, the sensor 14 receives both the authentication token and the encryption key seed (box 224).

In various implementations, the sensor 14 can store the authentication token for future sessions (box 226). The sensor 14 may compute the symmetric encryption key from the encryption key seed provided by the IoT gateway 16 (box 228). In some implementations, the key seed is XORd with the device ID, hashed, or processed using another algorithm to compute the symmetric encryption key.

In some implementations, the gateway 16 can compute a symmetric encryption key from the encryption key seed (box 230) in another optional step. In these and other implementations, the gateway 16 computes the symmetric encryption key using the same method as the sensor 14 to derive the same symmetric key. In various alternative implementations, the gateway 16 computes an encryption key from an encryption key seed (box 230) where the encryption key seed utilizes information specific to the sensor 14, such as the sensor ID, serial number, or other characteristic as would be appreciated. In these and other implementations, the encryption key is unique to the sensor 14.

### III. Secure Boot

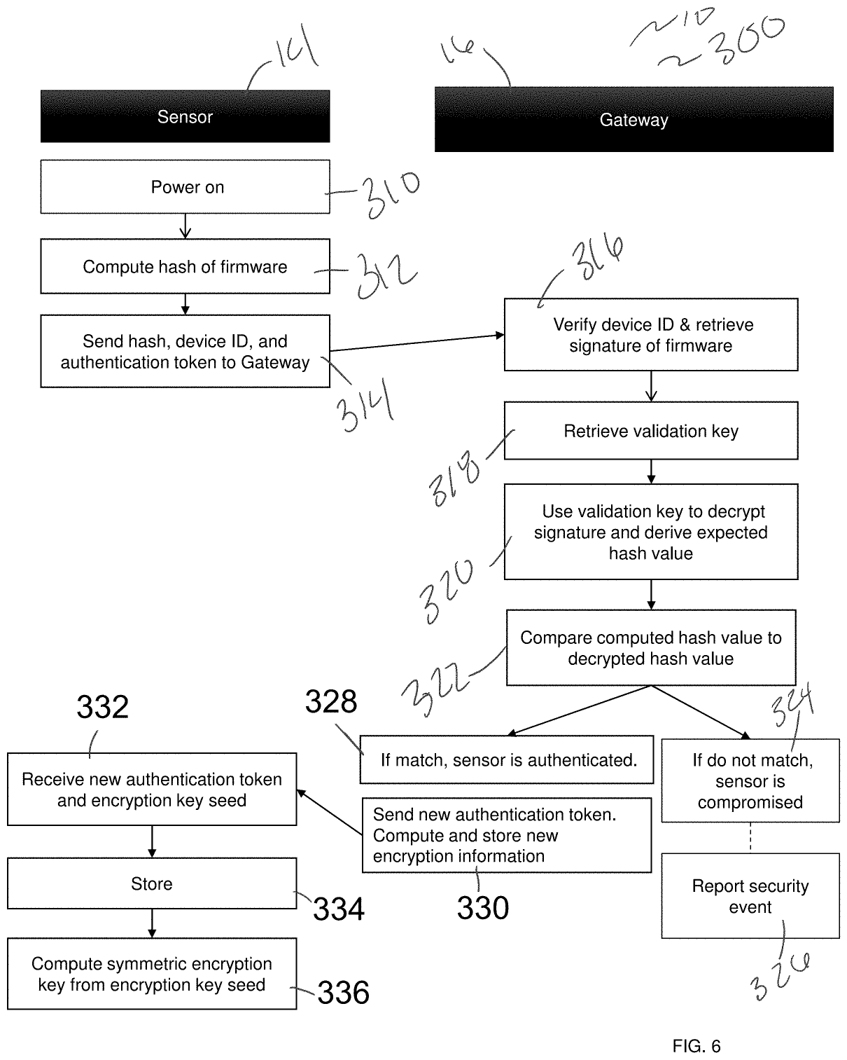

In various implementations, the system 10 can implement a secure boot process 300. The secure boot process 300 may involve a series of steps and substeps, each of which is optional and may be performed in any order or not at all. FIG. 6 shows an exemplary secure boot process 300 flow.

In one step, the sensors 14 may be powered on (box 310). In another optional step the sensor 14 may be constructed and arranged to compute a hash of the firmware (box 312). The sensor(s) 14 may then optionally send the hash of the firmware along with the device ID and authentication token to an IoT gateway 16 (box 314). In various implementations, the device ID may comprise a serial number.

In some implementations, the data that is sent between the sensor 14 and the gateway 16 may be encrypted. In these or other implementations, the data may be encrypted using the symmetric encryption key previously derived from the encryption key seed (for example as described at step 230 of FIG. 5).

In a further optional step, the gateway 16 may be constructed and arranged to verify the sensor device 14 (box 316), such as by using the authentication token. Further, the gateway 16 may be constructed and arranged to retrieve the signature of the firmware based on the device ID (box 316). The signature of the firmware may be retrieved from the IoT cloud 1 or server 2. In an alternative implementation, the signature of the firmware may be retrieved from storage on the gateway 16.

In various implementations, the gateway 16 may retrieve the validation key of the firmware based on the device ID (box 318). The gateway 16 may then be constructed and arranged to use the validation key to decrypt the signature and derive the expected firmware hash value (box 320). The gateway 16 may then compare (box 322) the computed hash value from the sensor 14 (from box 312) to the decrypted hash value from the signature (from box 320).

In implementations, where the values from the comparison (box 322) do not match, the IoT gateway 16 considers the sensor 14 to be compromised or cloned (box 324). In an optional step, the IoT gateway 16 may not accept any data from the sensor 14. In a further optional step, the IoT gateway 16 may report a security event to the cloud system 1 (box 326) or other notification system, as would be appreciated.

In implementations, where the values from the comparison (box 322) do match, the IoT gateway 16 considers the sensor 14 to be authentic (box 328). In an optional step, the gateway 16 may send a new authentication token to the sensor 14 (box 330). The sensor 14 may then receive the authentication token (box 332). In some implementations, the sensor 14 will store the authentication token (box 334) for subsequent sessions.

In a further optional step, the gateway 16 may also send a new encryption key seed to the sensor 14 (box 330). The sensor 14 may then compute the symmetric encryption key from the encryption key seed provided by the IoT gateway 16 (box 336). As noted above, the key may be XORd with the device ID, hashed, or computed using another algorithm as would be appreciated.

### IV. Update Flow

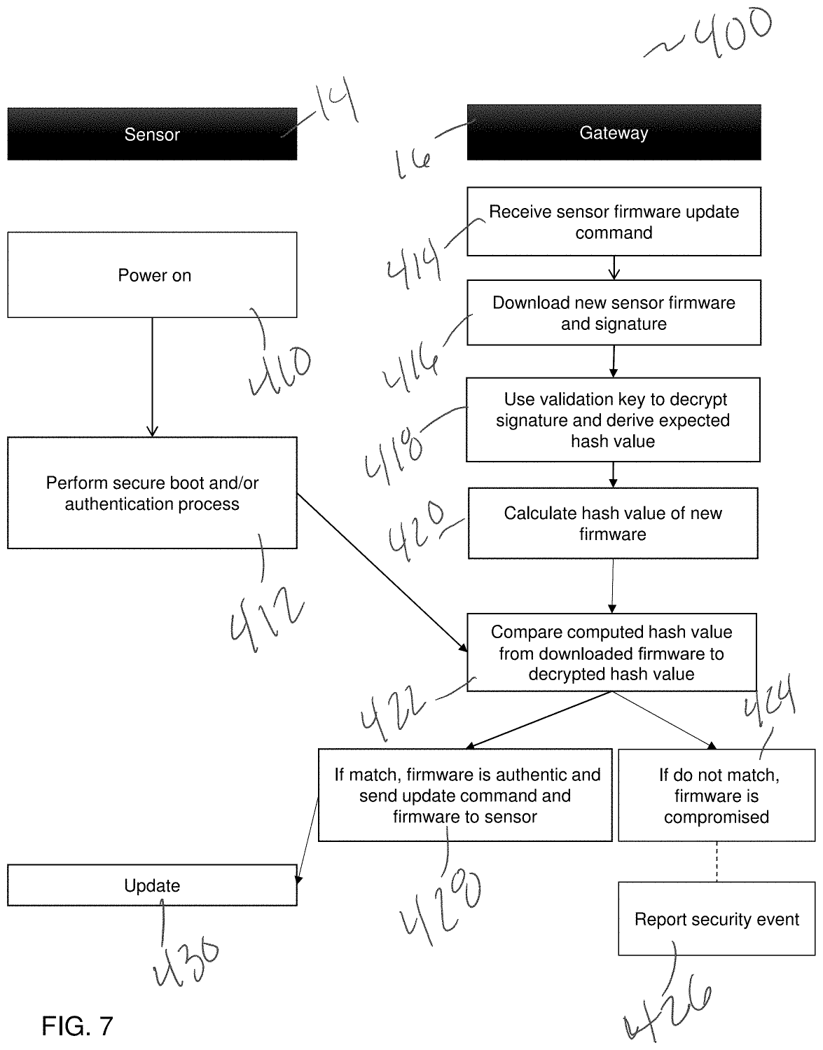

In further implementations, the system 10 can implement a secure update process 400 for updating firmware on sensor 14. An exemplary process flow for the update process is shown in FIG. 7. The secure update process 400 may involve a series of steps and substeps, each of which is optional and may be performed in any order.

In various implementations, the sensor 14 is powered on (box 410). In some implementations, the sensor 14 performs secure boot 300 and authentication 200 process as described above (box 412).

In one optional step, the gateway 16 may receive a firmware update for the sensors 14 via a command (box 414). In various implementations, the command (414) may be from the cloud system 1. The gateway 16 may then download any sensor firmware for the update along with the firmware signature, described herein (box 416).

In another optional step, the gateway 16 may be constructed and arranged to use a validation key to decrypt the signature and derive the expected firmware hash value (box 418). The gateway 16 may further calculate a hash value for the newly downloaded firmware (box 420).

In a further optional step, the gateway 16 is constructed and arranged to compare (box 422) the computed hash value from downloaded firmware (from box 420) to the decrypted hash value from the signature (box 418). In implementations, where the hash values to do not match the firmware is considered to be compromised (box 424). In an optional step, the system 400 may then report a security event (box 426) via any appreciated method.

In implementations, where the hash values match, the IoT gateway 16 may consider the firmware to be authentic and send a firmware update command to a sensor 14 (box 428). The gateway 16 may also send the new firmware to the sensor 14 (box 428). In various implementations, the sensor 14 is constructed and arranged to receive the authenticated firmware and update itself with the new firmware provided from the IoT gateway 16 (box 430). FIG. 7 shows an exemplary authentication flow.

### V. Developing and Signing Secure Firmware

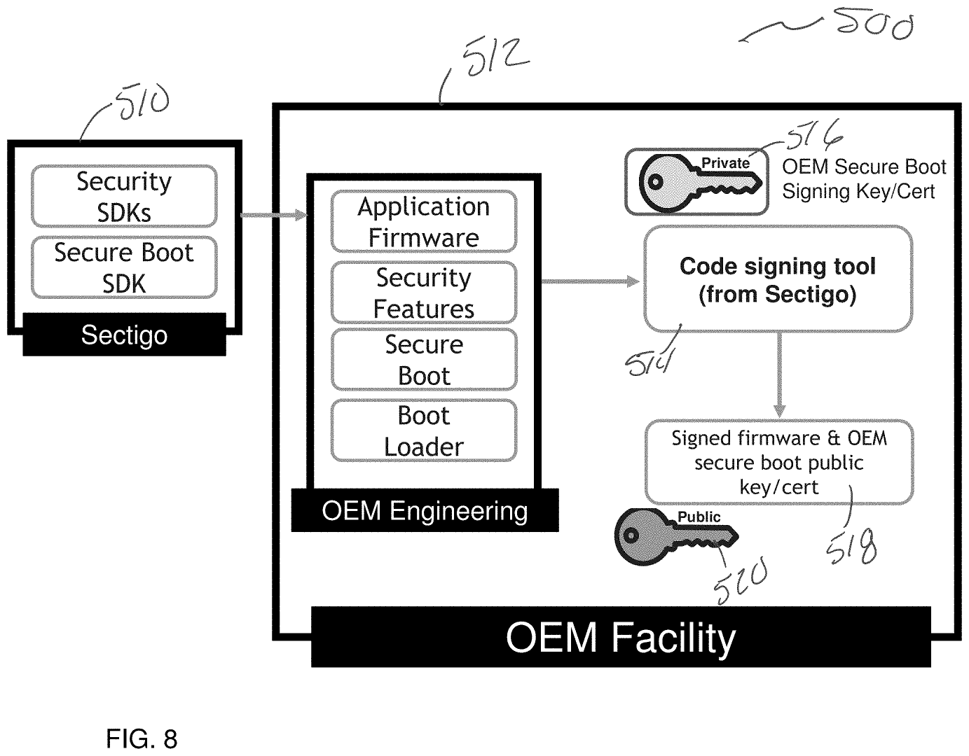

Shown in FIG. 8 is an exemplary system 500 for signing firmware. In various implementations, the system 500 of developing and signing firmware is decentralized including at least two separate entities. Of course, other implementations and processes are possible. The process 500 is described here as a series of optional step and substeps that can be performed in any order or not at all.

In one step, a first entity delivers security software development kits (SDKs) and a secure boot SDK to a second entity (box 510). In some implementations, the second entity is an OEM, which may integrate the security solutions into a platform 512.

In various implementations, the OEM may install a code signing server 514 or other code signing tool 514. In some implementations, the code signing tool 514 includes a TPM/HSM containing private key 516 for the OEMs secure boot signing key 518 and the corresponding public key/certificate 520.

The OEM may use the platform 512 to sign the secure firmware using the code signing tool 514, for example, by using the private code signing key 516. The code signing tool 514 may then produce signed firmware. The signed firmware may optionally be packaged with the OEM secure boot validation key. This secure signed firmware may be used with the authentication 200, secure boot 300, and update 400 processes described herein.

Although the disclosure has been described with references to various embodiments, persons skilled in the art will recognized that changes may be made in form and detail without departing from the spirit and scope of this disclosure.

1. A method for authenticating an IoT device comprising:
establishing communication between a sensor and a gateway;
verifying a sensor ID on the gateway;
generating an authentication token on the gateway; and
receiving the authentication token by the sensor.

2. The method of claim 1, further comprising:
generating an encryption key seed on the gateway; and
receiving the encryption key seed by the sensor.

3. The methods of claim 2, further comprising computing an encryption key from the encryption key seed.

4. A method for secure booting of an IoT device comprising:
powering on the IoT device;
computing a hash of firmware on the IoT device;
sending the hash to a gateway;
verifying the IoT device on the gateway;
retrieving a validation key and a signature on the gateway;
decrypting the signature and deriving an expected hash value; and
comparing the expected hash value to the hash.

5. The method of claim 4, further comprising sending an authentication token and encryption key seed to the IoT device.

6. The method of claim 4, further comprising reporting a security event when the expected hash value and the hash do not match.

7. A method for performing secure updates on an IoT device comprising:
downloading new firmware and a firmware signature;
decrypting the firmware signature with a validation key to derive an expected hash value;
calculating a hash value for the new firmware; and
comparing the expected hash value to the hash value.

8. The method of claim 7, further comprising updating the IoT device if the expected hash value and hash value match.

9. The method of claim 8, further comprising reporting a security event if the expected hash value and the hash value do not match.

10. The method of claim 1, further comprising:
installing the sensor on a sensor network;
configuring the gateway with the sensor ID of the sensor;
sending the authentication token from the gateway to the sensor;
storing the authentication token on the sensor.

11. The method of claim 10, further comprising:
generating an encryption key seed on the gateway; and
receiving the encryption key seed by the sensor.

12. The methods of claim 11, further comprising computing an encryption key from the encryption key seed.

13. The method of claim 12, wherein the encryption key seed uses information specific to the sensor.

14. The method of claim 1, further comprising setting the gateway to installation mode.

15. The method of claim 4, further comprising encrypting the hash, authentication token, encryption key seed, and device ID when sending between the sensor and the gateway.

16. The method of claim 4, further comprising authenticating the IoT device when the expected hash value and the hash value match, and sending a new authentication token to the IoT device.

17. The method of claim 5, further comprising sending a device ID to the gateway.

18. The method of claim 7, further comprising securely booting the IoT device.

19. The method of claim 7, further comprising authenticating the IoT device.

20. The method of claim 7, further comprising receiving the new firmware by the IoT device if the expected hash value and hash value match.
